(19) United States
(12) Patent Application Publication
(10) Pub. No.: US 2008/0224555 A1
(43) Pub. Date: Sep. 18, 2008

(54) Method and Device For Controlling a Magnetic Bearing

(75) Inventors: Ingo Menz, Berlin (DE); Hartmut Walter, Berlin (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, Munchen (DE)

(21) Appl. No.: 11/813,819

(22) PCT Filed: Dec. 21, 2005
(86) PCT No.: PCT/EP05/57029

§ 371 Date: Jul. 12, 2007

(30) Foreign Application Priority Data
Jan. 12, 2005 (DE) 10 2005 001 494.1

(51) Int. Cl. H02K 7/09; G05B 11/01; G05B 1/02

(52) U.S. Cl. 310/90.5; 318/629; 318/607

(57) ABSTRACT

A detection device (8) detects radial deflections (x, y) of a rotating element (2) which is mounted in a base (1) by means of a magnetic bearing system (3) so as to rotated about a rotational axis (4) and feeds these deflections to a control device (9). Said control device uses the radial deflections (x, y) to determine control signals (Sx, Sy) for the magnetic bearing system (3) and outputs them to the magnetic bearing system (3). The detection device (8) also detects a rotary frequency (f) of the rotating element (2) and feeds it to the control device (9). The control device eliminates from the radial deflections (x, y) at least one frequency portion that comprises the portions of the radial deflections (x, y) having frequencies close to a filter frequency that has a defined ratio to the rotary frequency (f). The control device (9) uses the frequency portion to determine frequency control signals (Fx, Fy) in accordance with a frequency control model. The control device determines a remaining portion using the difference between the radial deflections (x, y) and the frequency portion, and uses said remaining portion to determine remaining control signals (Rx, Ry) in accordance with a remaining control model. The controls signals (Sx, Sy) are then determined by summing up the frequency control signals (Fx, Fy) and the remaining control signals (Rx, Ry).

The present invention relates to a control method for a magnetic bearing in which a rotating element is mounted in a base body such that it can rotate about a rotation axis, with a detection device detecting radial deflections of the rotating element relative to the rotation axis and supplying them to a control device which uses the radial deflections of the rotating element to determine control signals for the magnetic bearing, and emits them to the magnetic bearing.

The present invention also relates to a device which corresponds to it.

Control methods for magnetic bearings, and the devices which correspond to them, are generally known. In this context, by way of example, reference should be made to DE-A-31 50 122.

Particularly in the case of devices which have rotating elements which rotate at higher speed, so-called critical rotation speeds can occur below the maximum rotation speed of the rotating element. If the rotation speed of the rotating element is in this case variable, these rotation speeds may also occur in the rotation speed control range. At critical rotation speeds, the rotating element is highly susceptible to oscillation and reacts with severe oscillations even in response to small and very small stimuli. The relevant guidelines therefore require a safety margin between the operating range of the rotating elements and the critical rotation speeds, which can be determined in advance.

In the prior art, attempts have been made by active damping of the rotating elements at the critical rotation speeds and by good balancing to ensure that the rotating element runs as quietly as possible even at the critical rotation speeds. Despite all of the efforts from the prior art, more severe oscillations than those required in accordance with the guidelines often have to be tolerated, however, at the critical rotation speeds. Depending on the situation in the individual case, these relatively severe oscillations are tolerated, or else the corresponding rotation speed range is blocked.

Active magnetic bearings admittedly allow the bearing stiffness and the bearing damping to be varied as a function of the rotation speed. However, even active magnetic bearings such as these do not make it possible to solve the problems of the critical rotation speeds in the prior art.

The object of the present invention is to provide a control method for a magnetic bearing of the type mentioned initially, and to provide the device which corresponds to it, by means of which the problems relating to the critical rotation speeds can be solved.

For the control method, the object is achieved

in that the detection device also detects a rotation frequency of the rotating element and supplies it to the control device,

in that the control device splits at least one frequency component off from the radial deflections of the rotating element, which frequency component comprises those components of the radial deflections of the rotating element which are at frequencies in the vicinity of a filter frequency which has a predetermined ratio to the rotation frequency,

in that the control device uses the frequency component to determine frequency control signals in accordance with a frequency control scheme,

in that the control device uses the difference between the radial deflections of the rotating element and the frequency component to determine a residual component, and uses the residual component to determine residual control signals in accordance with a residual control scheme, and

in that the control device determines the control signals for the magnetic bearing by addition of the frequency control signals and the residual control signals.

For the device, the object is achieved by the corresponding device features in claim 14.

If the detection device detects not only the rotation frequency but also an instantaneous rotation position of the rotating element, and supplies this to the control device, the control method according to the invention operates even better. If a pulse transmitter for the detection device in each case produces a trigger pulse at predetermined rotation positions of the rotating element for this purpose, and transmits this to the control device, the rotation frequency and the rotation position can be detected particularly accurately. In this case, the pulse transmitter preferably produces and transmits one and only one trigger pulse per revolution of the rotating element.

If the control device determines the frequency control signals and/or the residual control signals as a function of the supplied rotation position of the rotating element, and emits this to the magnetic bearing, it is possible to compensate even better for the radial deflections. In particular, this is because it is possible in this case to emit the control signals within each revolution of the rotating element as a function of its rotation position (extrapolated, of course).

If the frequency control scheme is dependent on the rotation frequency, the control method according to the invention operates particularly flexibly. In this case, in particular, it is possible for the control device to determine the frequency control signals in such a way that the magnetic bearing has a negative dynamic stiffness in the vicinity of the filter frequency.

The residual control scheme, in contrast, may be independent of the rotation frequency. It is preferably defined in such a manner that the control device determines the residual control signals in such a manner that the magnetic bearing counteracts the radial deflections of the rotating element, that is to say it has a positive dynamic stiffness.

The control method according to the invention is advantageous in particular when it is designed for a resonant frequency at which the rotating element would be resonant if all of the control signals were determined by the control device in accordance with the residual control scheme.

The filter frequency is generally an integer multiple of half the rotation frequency. In many cases, it is even an integer multiple of the rotation frequency. In the simplest case, the filter frequency is identical to the rotation frequency.

The control method according to the invention is preferably used when the rotation speed of the rotating element can be controlled in a rotation frequency range which contains the resonant frequency.

In principle, the present invention can be applied to any type of device. By way of example, it is used for electrical machines, turbines or compressors.

Further advantages and details will become evident from the following description of one exemplary embodiment and in conjunction with the drawings in which, illustrated in an outline form:

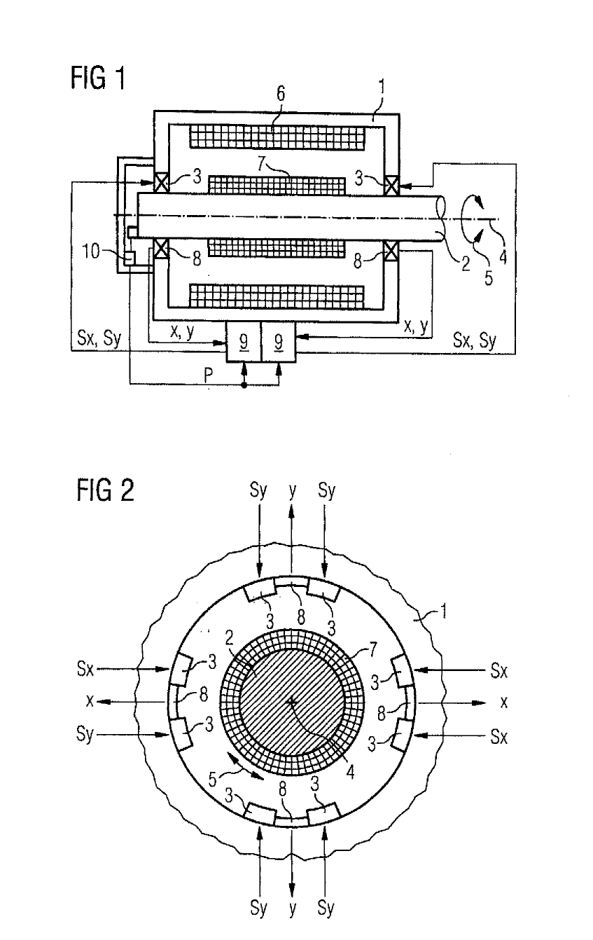

FIG. 1 shows a device with a base body and a rotating element,

FIG. 2 shows a section through a magnetic bearing for the device in FIG. 1,

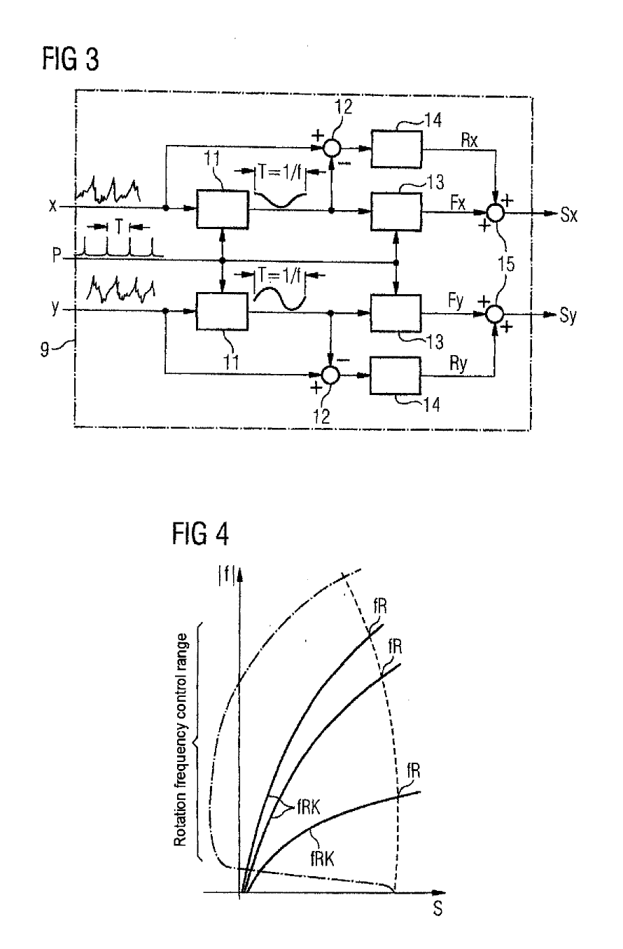

FIG. 3 shows, schematically, the determination of control signals for the magnetic bearing in FIG. 2, and

FIG. 4 shows a rotation-speed/stiffness graph (so-called Kellenberger diagram).

As shown in FIG. 1, a device has a base body 1 and a rotating element 2. The rotating element 2 is mounted in the base body 1 by means of magnetic bearings 3 in such a manner that it can rotate about a rotation axis 4. This is indicated by a double-headed arrow 5 in FIG. 1. In this case, in principle, the rotation axis 4 may assume any desired orientation in space (horizontal, vertical, inclined).

As shown in FIG. 1, a stator 6 is arranged in the base body 1. A rotor 7 is arranged in a manner corresponding to this on the rotating element 2. The device in FIG. 1 is thus in the form of an electrical machine. However, this embodiment is purely exemplary. In principle, the present invention can be used for any type of device, for example turbines or compressors.

As shown in FIGS. 1 and 2, the device has one detection device 8 per magnetic bearing 3. The detection devices 8 can be used, inter alia, to detect radial deflections x, y of the rotating element 2 relative to the rotation axis 4 in the region of the magnetic bearings 3. The detection devices 8 in this case in general form an angle of about 90° tangentially with respect to the rotation axis 4. However, this is not absolutely essential.

The detection devices 8 are connected for data transmission purposes to control devices 9. The detection devices 8 are thus able to supply the radial deflections x, y of the rotating element 2 detected by them to their corresponding control devices 9.

The control devices 9 use the radial deflections x, y of the rotating element 2 to determine corresponding control signals Sx, Sy. They are connected to the magnetic bearings 3 for control purposes. They are therefore able to emit the control signals Sx, Sy determined by them to the magnetic bearings 3. In this case, the control signal Sx for reaction to the radial deflections x are determined as shown in FIG. 3 independently of the radial deflections y. An analogous situation applies to the control signals Sy. However, it would also be possible to take account of any mutual interaction between the radial deflections x, y of a single magnetic bearing 3 and/or the radial deflections x, y between a plurality of magnetic bearings 3. This is generally known to those skilled in the art.

As shown in FIG. 1, the detection devices 8 also have a pulse transmitter 10. The pulse transmitter 10 may in this case be shared by the detection devices 8. The pulse transmitter 10 in each case produces a trigger pulse P at predetermined rotation positions of the rotating element 2, and transmits this to the control devices 9. According to the exemplary embodiment, the pulse transmitter 10 in this case produces and transmits one and only one trigger pulse P per revolution of the rotating element 2. In principle, however, it would also be possible to produce a plurality of trigger pulses P per revolution of the rotating element 2.

The rotation frequency f of the rotating element 2 is obtained directly or indirectly from the time interval T between the trigger pulses P emitted from the pulse transmitter 10. The detection devices 8 therefore also use the emission of the trigger pulse P from the pulse transmitter 10 to detect the rotation frequency f of the rotating element 2, and supply this rotation frequency f to their control devices 9. Since, furthermore, the trigger pulses P are emitted from the pulse transmitter 10 at predetermined rotation positions, the detection devices 8 detect not only the rotation frequency f but also the respective instantaneous rotation position of the rotating element 2, and supply this to their respective control device 9. The control devices 9 are thus able to determine the frequency, residual and control signals Fx, Fy, Rx, Ry, Sx, Sy with the correct phases, and also to emit them in the correct phase (that is to say as a function of the supplied rotation position and the phase angle) to the magnetic bearings 3.

As shown in FIG. 3, the control devices 9 have configurable frequency filters 11 (bandpass filters 11) on the input side. These frequency filters 11 are supplied not only with the radial deflections x, y but also with the trigger pulse P.

According to the exemplary embodiment, the trigger pulse P and the corresponding rotation frequency f are used to configure the frequency filters 11 in such a manner that they filter out from the radial deflections x, y of the rotating element 2 those frequency components which are at frequencies in the vicinity of an integer multiple of the rotation frequency f. The frequency filters 11 pass only these components. The control devices 9 therefore split off from the radial deflections x, y of the rotating element 2 a component—referred to in the following text as a frequency component—which comprises the components of the radial deflections x, y of the rotating element 2 which are at frequencies in the vicinity of this integer multiple of the rotation frequency f.

As shown in FIG. 3, one period of the frequency component that is passed on corresponds essentially to the time interval T between the trigger pulses P. The frequency component thus comprises the components of the radial deflections x, y of the rotating element 2 which are at frequencies in the vicinity of the rotation frequency f itself. However, in principle, it would also be possible to filter out components in the vicinity of a “real” integer multiple of the rotation frequency f or of half the rotation frequency f. Any other desired filter frequencies are also possible provided that they have only a predetermined relationship with the rotation frequency. It is also possible to arrange a plurality of said frequency filters 11 in parallel, in which case each frequency filter 11 filters out a different frequency component, that is to say for example it is tuned to a different integer multiple of the rotation frequency f. It is thus possible to treat each filtered-out frequency component independently of the other filtered-out frequency components, and also independently of the residual component (see the following text).

The filtered-out frequency component and the entire radial deflections x, y are supplied to subtractors 12. The subtractors 12 use the entire frequency deflections x, y of the rotating element 2 and of the filtered-out frequency component to determine their difference. This difference is referred to in the following text as the residual component.

The control devices 9 also have frequency control signal determining means 13 and residual control signal determining means 14.

The frequency components are supplied to the frequency control signal determining means 13. These use the frequency components supplied to them to determine frequency control signals Fx, Fy, in accordance with a frequency control scheme. The residual components are supplied to the residual control signal determining means 14. These determine residual control signals Rx, Ry in accordance with a residual control scheme.

The frequency control signals Fx, Fy and the residual control signals Rx, Ry are supplied to adders 15 which determine the control signals Sx, Sy by addition of the frequency control signals Fx, Fy and of the residual control signals Rx, Ry.

The residual control signal determining means 14 generally determine the residual control signals Rx, Ry independently of the rotation frequency f. The residual control scheme is therefore generally independent of the rotation frequency f, and is retained independently of the rotation frequency f. There is therefore no need, see FIG. 3, to supply them with the trigger pulses P or the rotation frequency f.

However, even if, as is indicated by dashed lines in FIG. 4, the residual control scheme is slightly dependent on the rotation frequency f, this makes no significant difference. This is because, in both cases, the residual control signal determining means 14 determine the residual control signals Rx, Ry in such a way that the magnetic bearings 3 counteract the radial deflections x, y of the rotating element 2. With respect to the residual control signals Rx, Ry, the magnetic bearings 3 therefore have a dynamic stiffness S as shown by dashed lines in FIG. 4, which is positive.

The frequency control signal determining means 13 in contrast generally determine the frequency control signals Fx, Fy as a function of the rotation frequency f. The frequency control scheme is therefore dependent on the rotation frequency f, and varies as a function of the rotation frequency f. This can clearly be seen in FIG. 4. In particular, this is because the dynamic stiffness S of the magnetic bearings 3 with respect to the frequency control signal Fx, Fy is a function of the rotation frequency f. The frequency control signal determining means 13 are therefore supplied with the trigger pulse P and the rotation frequency f, as shown in FIG. 3.

FIG. 4 likewise shows resonant frequency curves fRK, from which it is possible to see the resonant frequencies fR at which the rotating element 2 would be resonant if all of the control signals Sx, Sy were determined in accordance with the residual control scheme. As can be seen from FIG. 4, the frequency control signal determining means 13 always determine the frequency control signals Fx, Fy in such a manner, however, that the rotating element 2 is not resonant even at the resonant frequencies fR with the type of control signal determination process according to the invention. In this case, the frequency control signal determining means 13 in this case determine the frequency control signals Fx, Fy over a portion of the possible frequency range in such a manner that the magnetic bearings 3 have a dynamic stiffness S—shown by dashed-dotted lines in FIGS. 4—which is negative, in the vicinity of the filter frequency (or in this case in the vicinity of the rotation frequency f) for which the frequency filters 11 are configured.

Finally, as can also be seen from FIG. 4, the rotation speed of the rotating element according to the present invention can be controlled in a rotation frequency range which contains at least one resonant frequency fR—in the present case even a plurality of resonant frequencies fR.

The control separation of the static support function for the magnetic bearings 3—keyword residual control signals Rx, Ry—according to the invention whose dynamic characteristics—keyword frequency control signals Fx, Fy—thus result in a considerable improvement in the oscillation response of the rotating element 2, and, associated with this, allow a considerable extension of the permissible rotation frequency control range. This can be achieved in particular because the procedure according to the invention makes it possible to achieve negative dynamic stiffness S for the active magnetic bearings 3, with out endangering the stability of the magnetic bearings 3.

1.-28. (canceled)

29. A control method for a magnetic bearing rotatably supporting a rotating element in a base body for rotation about a rotation axis, comprising the steps of:
detecting with a detection device a first radial deflection in a first radial direction and a second radial deflection in a second radial direction of the rotating element relative to the rotation axis and supplying signals corresponding to the first radial deflection and the second radial deflection to a control device,
detecting with the detection device a rotation frequency of the rotating element and supplying the rotation frequency to the control device,
defining a filter frequency having a predetermined ratio to the rotation frequency,
extracting with the control device from the first radial deflection at least one first frequency component having components of the first radial deflection located at frequencies in the vicinity of the filter frequency, and extracting from the second radial deflection at least one second frequency component having components of the second radial deflection that are at frequencies in the vicinity of the filter frequency,
determining with the control device a first residual component from the difference between the first radial deflection and the at least one first frequency component, and a second residual component from the difference between the second radial deflection and the at least one second frequency component, with both the first and the second residual components being determined independent of the rotation frequency,
determine with the control device in accordance with a frequency control scheme from the at least one first frequency component a first frequency control signal, and from the at least one second frequency component a second frequency control signal,
determining with the control device in accordance with a residual control scheme from the first residual component a first residual control signal, and from the second residual component a second residual control signal,
determining with the control device a first control signal by adding the first frequency control signal and the first residual control signal, and a second control signal by adding the second frequency control signal and the second residual control signal, and
transmitting from the control device the first and the second control signals to the magnetic bearing.

30. The control method of claim 29, further comprising the steps of detecting with the detection device the rotation frequency and an instantaneous rotation position of the rotating element, and supplying the rotation frequency and the instantaneous rotation position to the control device.

31. The control method of claim 30, further comprising the steps of generating a trigger pulse with a pulse transmitter associated with the detection device at the predetermined rotation position of the rotating element, and transmitting the trigger pulse to the control device.

32. The control method of claim 31, wherein the pulse transmitter produces a single trigger pulse for each revolution of the rotating element.

33. The control method of claim 30, wherein the frequency control signals or the residual control signals, or both, are determined as a function of the detected instantaneous rotation position of the rotating element, and transmitting the corresponding control signals to the magnetic bearing.

34. The control method of claim 29, wherein the frequency control scheme depends on the rotation frequency.

35. The control method of claim 29, wherein the first and second frequency control signals are determined so that the magnetic bearing has a negative dynamic stiffness in the vicinity of the filter frequency.

36. The control method of claim 29, wherein the residual control scheme is independent of the rotation frequency.

37. The control method of claim 29, wherein the first and second residual control signals are determined so that the magnetic bearing counteracts the first and second radial deflections of the rotating element.

38. The control method of claim 29, wherein the control method is designed for a resonant frequency at which the rotating element would be resonant if the first and second control signals were determined with the control device in accordance with the residual control scheme, and wherein the control device determines the first and second frequency control signals so as to suppress resonances of the rotating element at the resonant frequency.

39. The control method of claim 29, wherein the filter frequency is an integer multiple of half the rotation frequency.

40. The control method of claim 29, wherein the filter frequency is an integer multiple of the rotation frequency.

41. The control method of claim 29, wherein the filter frequency is equal to the rotation frequency.

42. A device with a base body, a magnetic bearing disposed in the base body, and a rotating element supported by the magnetic bearing for rotation about a rotation axis, the device comprising:
a detection device for detecting a rotation frequency of the rotating element as well as a first radial deflection of the rotating element in a first radial direction relative to the rotation axis and a second radial deflection of the rotating element in a second radial direction relative to the rotation axis,
a filter having a filter frequency with a predetermined ratio to the rotation frequency,
a control device connected with the detection device for data transmission, said control device receiving from the detection device the corresponding first and second radial deflections and the rotation frequency,
wherein the control device is configured to:
extract from the first radial deflection at least one first frequency component having components of the first radial deflection located at frequencies in the vicinity of the filter frequency, and extracting from the second radial deflection at least one second frequency component having components of the second radial deflection that are at frequencies in the vicinity of the filter frequency,
determine a first residual component from the difference between the first radial deflection and the at least one first frequency component, and a second residual component from the difference between the second radial deflection and the at least one second frequency component, with both the first and the second residual components being determined independent of the rotation frequency,
determine in accordance with a frequency control scheme from the at least one first frequency component a first frequency control signal, and from the at least one second frequency component a second frequency control signal,
determine in accordance with a residual control scheme from the first residual component a first residual control signal, and from the second residual component a second residual control signal,
determine a first control signal by adding the first frequency control signal and the first residual control signal, and a second control signal by adding the second frequency control signal and the second residual control signal, and
transmit the first and the second control signals to the magnetic bearing.

43. The device of claim 42, wherein the detection device further detects an instantaneous rotation position of the rotating element, and transmits the instantaneous rotation position to the control device.

44. The device of claim 42, wherein the detection device comprises a pulse transmitter which produces a trigger pulse at a predetermined rotation position of the rotating element, and transmits the trigger pulse to the control device.

45. The device of claim 44, wherein the pulse transmitter produces the trigger pulse a single rotation position per revolution of the rotating element.

46. The device of claim 43, wherein the control device determines the first and second frequency control signals or the first and second residual control signals, or both, as a function of the instantaneous rotation position of the rotating element, and transmits the corresponding frequency and residual control signals to the magnetic bearing.

47. The device of claim 42, wherein the control device varies the frequency control scheme as a function of the rotation frequency.

48. The device of claim 42, wherein the control device determines the first and second frequency control signals so that the magnetic bearing has a negative dynamic stiffness in the vicinity of the filter frequency.

49. The device of claim 42, wherein the control device retains the residual control scheme independent of the rotation frequency.

50. The device of claim 42, wherein the control device determines the first and second residual control signals so that the magnetic bearing counteracts the first and second radial deflections of the rotating element.

51. The device of claim 42, wherein the control device controls the device so as to operate at a resonant frequency at which the rotating element would be resonant if the first and second control signals were determined with the control device in accordance with the residual control scheme, and wherein the control device determines the first and second frequency control signals so as to suppress resonances of the rotating element at the resonant frequency.

52. The device of claim 51, wherein the control device controls the rotation speed of the rotating element in a rotation frequency range which includes the resonant frequency.

53. The device of claim 42, wherein the filter frequency is an integer multiple of half the rotation frequency.

54. The device of claim 42, wherein the filter frequency is an integer multiple of the rotation frequency.

55. The device of claim 42, wherein the filter frequency is equal to the rotation frequency.

56. The device of claim 42, wherein the device is implemented in form of an electrical machine, a turbine or a compressor.

57. A control method for a magnetic bearing rotatably supporting a rotating element in a base body for rotation about a rotation axis, comprising the steps of:
detecting with a detection device a rotation frequency of the rotating element as well as a first radial deflection in a first radial direction and a second radial deflection in a second radial direction of the rotating element relative to the rotation axis,
supplying the rotation frequency as well as signals corresponding to the first radial deflection and the second radial deflection to a control device,
defining a filter frequency having a predetermined ratio to the rotation frequency,
determining with the control device from the first and second radial deflections corresponding first and second control signals for the magnetic bearing, wherein the first and second control signals are determined by:
extracting from the first and second radial deflections at least one frequency component located at a frequency proximate to the filter frequency,
determining from the at least one frequency component first and second frequency control signals in accordance with a frequency control scheme,
determining first and second residual components based on a difference between, on one hand, the first and second radial deflections and, on the other hand, the at least one frequency component, with both the first and the second residual components being determined independent of the rotation frequency,
determining from the first and second residual components corresponding first and second residual control signals based on a residual control scheme, and
adding the first frequency control signal and the first residual control signal, and the second frequency control signal and the second residual control signal, respectively, and
transmitting the first and second control signals to the magnetic bearing.
